(19) United States
(12) Patent Application Publication
(10) Pub. No.: US 2002/0159725 A1
(43) Pub. Date: Oct. 31, 2002

(54) Electrically-terminated, optically-coupled communication cables

(75) Inventor: Willard K. Bucklen, Greensboro, NC (US)

Correspondence Address: KOPPEL, JACOBS, PATRICK & HEYBL, AN ASSOCIATION OF PROFESSIONAL LAW CORPORATIONS, 555 ST. CHARLES DRIVE, SUITE 107, THOUSAND OAKS, CA, 91360, US

(73) Assignee: ANALOG DEVICES, INC.

(21) Appl. No.: 10/116,466

(22) Filed: Apr. 3, 2002

Related U.S. Application Data
(60) Provisional application No. 60/281,643, filed on Apr. 5, 2001.

(51) Int. Cl. G02B 6/44; G02B 6/38; G02B 6/36

(52) U.S. Cl. 385/101; 385/75; 385/88

(57) ABSTRACT

Electrically-terminated, optically-coupled communication cables are provided that are suitable for transport of high data rates and are safe for use in consumer communication applications. This safety is ensured with integral cable elements and permanent assembly of these elements.

### CROSS REFERENCES TO RELATED APPLICATIONS

This application claims the benefit of U.S. Provisional Application Serial No. 60/281,643 filed Apr. 5, 2001.

### BACKGROUND OF THE INVENTION

1. Field of the Invention

The present invention relates generally to communication cables.

2. Description of the Related Art

Communication cables are used for point-to-point transportation of communication signals (e.g., data signals) wherein they have historically carried electrical communication signals and have been configured to minimize modification of the signals during transport. In contrast to electrical communication cables, optical fibers form a different communication cable type because they are configured to reflectively carry (i.e., propagate) light communication signals.

In the use of optical fibers, electrical communication signals have typically been converted to corresponding light communication signals with semiconductor lasers. The light communication signals have then been reflectively introduced into the optical fibers and reflectively guided to photodiodes which, in response, generate electrical communication signals that mimic the original signals.

At least one manufacturer has integrated optical fibers to form optical-fiber cables, provided connectors that house the semiconductor lasers and photodiodes and configured the connectors to releasably mate with ends of the optical-fiber cables. One of the connectors, therefore, can be released from the optical-fiber cable so that laser-generated light issues from the unmated optical fibers. Because such communication cables present a significant source of eye damage, they are generally restricted in public applications (e.g., consumer electronics) to the transport of light signals from low-power light-emitting diodes (LEDs). Although this reduces the danger of eye damage, LED signals generally support only low data rates that may suffice in some consumer applications (e.g., optical audio connections) but which are insufficient for many modern communication applications (e.g., generation of high-resolution displays in the notebook and desk-top computer markets).

### BRIEF SUMMARY OF THE INVENTION

The present invention is directed to electrically-terminated, optically-coupled communication cables that can transport high data rates and are safe for use in consumer communication applications. This safety is ensured with integral cable elements and permanent assembly of these elements. Accordingly, disassembly of cable elements is necessarily destructive.

The novel features of the invention are set forth with particularity in the appended claims. The invention will be best understood from the following description when read in conjunction with the accompanying drawings.

### BRIEF DESCRIPTION OF THE DRAWINGS

FIGS. 1A-1C are top, side and end views of an electrically-terminated, optically-coupled transmission cable embodiment of the present invention;

FIG. 1D is a substantially-enlarged view of structure within the curved line ID of FIG. 1A;

FIG. 2 is a substantially-enlarged view of structure within the curved line 2 of FIG. 1A; and

FIG. 3 is a schematic of structure in FIGS. 1A-1D and 2.

### DETAILED DESCRIPTION OF THE INVENTION

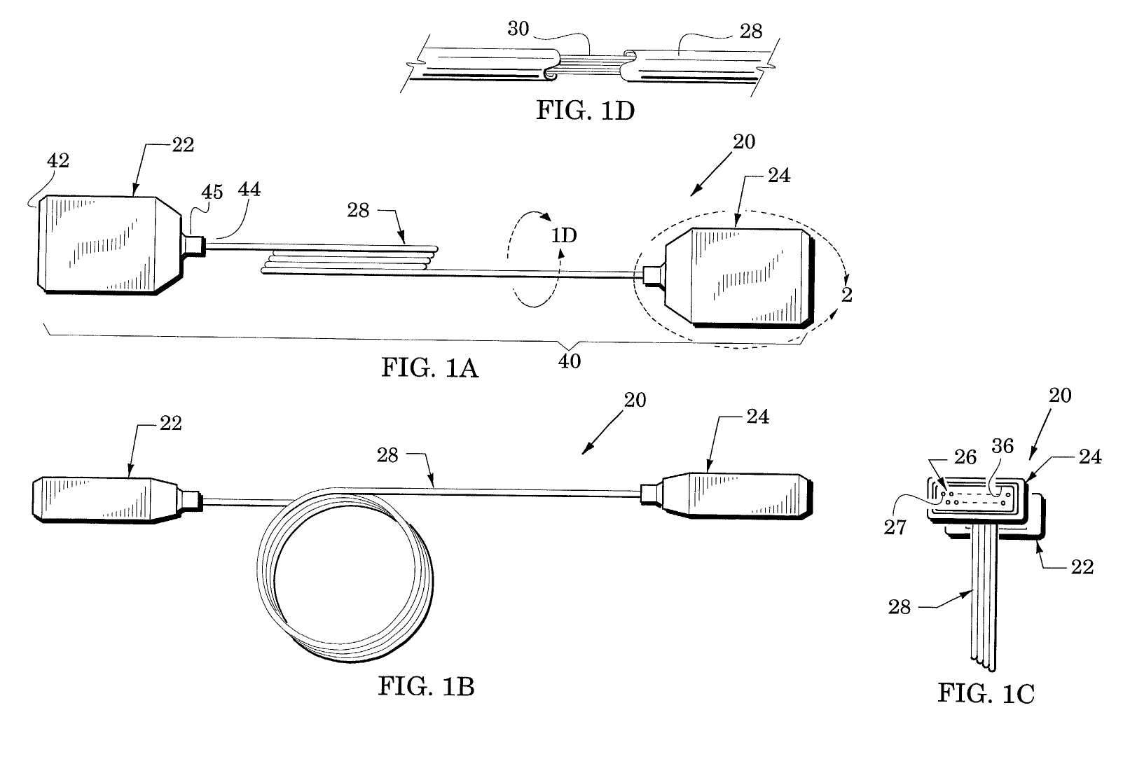

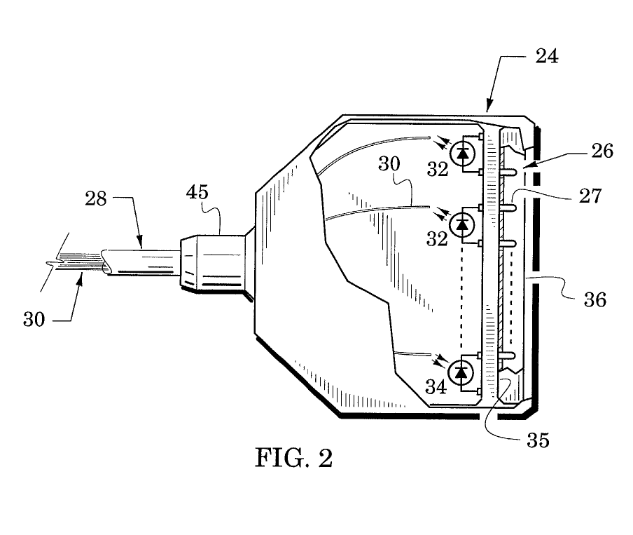

FIGS. 1A-1D and 2 illustrate a communication cable embodiment 20 of the present invention which features external electrical terminations and shielded internal optical transmission. The cable 20 thus provides the advantages of optical signals and the safety of conventional electrical communication cables.

In particular, the cable 20 is formed with first and second integral shells 22 and 24 that each include an array 26 of electrical contacts 27 which introduce electrical signals into the communication cable and extract other electrical signals from the cable. A flexible tube 28 permanently couples the first and second shells 22 and 24 and a plurality of optical fibers 30 are permanently contained within the tube and extend into the first and second shells 22 and 24.

As shown in FIG. 2, at least one semiconductor laser 32 (e.g., a vertical cavity surface emitting laser (VCSEL)) is shielded within the second shell 24. The laser is coupled between respective contacts 27 of the array 26 and is arranged to radiate a light signal into a respective one of the optical fibers 30. Similarly, at least one photodiode 34 is shielded within the second shell 24 and is coupled between respective contacts 27 of the array 26. The photodiode is arranged to receive a light signal from a respective one of the optical fibers 30.

Although not shown, at least one laser may be shielded within the first shell 22 and coupled between respective contacts 27 of a similar array. This laser may be arranged to radiate a light signal into an optical fiber for reception by the photodiode 34 in the second shell 24. Finally, at least one photodiode may be shielded within the first shell 22 and coupled between respective contacts 27 of a similar array. This photodiode may be arranged to receive the light signal from the laser 32 in the second shell 34.

An integral electrically-terminated, optically-coupled communication cable 20 is thus provided which propagates optical signals internally but interfaces externally with electrical signals. Because internal radiation of the optical signals is blocked by the first and second shells 22 and 24 and the tube 28, the communication cable 20 is suitable for high-speed consumer communication applications (e.g., generation of high-resolution computer displays).

The electrical contacts 27 are configured to releasably mate with external corresponding contacts. Thus, the communication cable 20 can be repeatably mated to and released from external electrical connectors. Different ones of the electrical contacts 27, for example, may be sockets that releasably mate with external pins and others may be pins that releasably mate with external sockets. In other cable embodiments, the contacts 27 may be configured for attachment with solder to external elements.

As shown in FIG. 2, the contacts 27 may be carried by a web 35 which is a portion of the shells. In other cable embodiments, the web may be augmented by or replaced by metal housings 36 that permanently couple the electrical contacts 27 to the first and second shells 22 and 24 and ensure containment of laser radiation. Preferably, these housings 34 are shaped to releasably mate with similar external housings.

Preferably, the first and second shells 22 and 24 and the flexible tube 28 are molded or extruded one-piece units that are permanently joined to each other. Alternatively, each of these elements are formed from more than one piece but are permanently joined to form integral units.

In another communication cable embodiment, the first and second shells 22 and 24 and the flexible tube 28 are parts of a single integral plastic sheath 40 (as indicated in FIG. 1A). The sheath ensures the integrity of these elements and, thus, ensures that laser radiation is safely contained. In particular, the sheath 40 provides each shell with a first end 42 that is configured to permanently receive the electrical contacts 27 and a second end 44 that may transition, e.g., with a boss 45, into the tube 28.

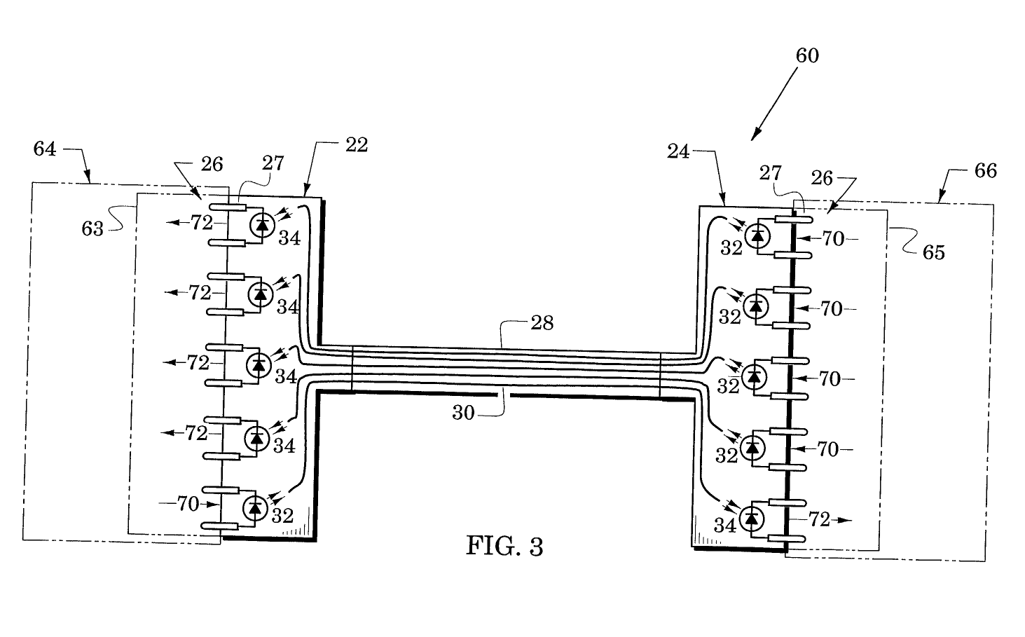

FIG. 3 is a schematic 60 that shows first and second shells 22 and 24 coupled by a tube 28 and shows optical fibers 30 that pass through the tube and extend into the first and second shells. Arrays 26 of electrical contacts 27 terminate each of the first and second shells.

In an exemplary configuration, the first shell 22 contains several photodiodes 34 that are coupled across respective pairs of contacts 27 and are arranged to receive optical signals from respective optical fibers. The first shell also contains a semiconductor laser 32 that is coupled across a respective pair of contacts 27 and is arranged to radiate optical signals into a respective optical fiber. In order to communicate with the first shell, the second shell 24 contains several semiconductor lasers 32 that are coupled across respective pairs of contacts 27 and are arranged to radiate optical signals to the photodiodes 34 within the first shell. The second shell also contains a photodiode 34 that is coupled across a respective pair of contacts 27 and is arranged to receive optical signals from the semiconductor laser 32 within the first shell 22.

The electrical contacts 27 of the first shell 22 can thus releasably mate with contacts of an external electrical connector 63 that is part of a first communication system 64. Similarly, the electrical contacts 27 of the second shell 24 can thus releasably mate with contacts of an external electrical connector 65 that is part of a second communication system 66. In an exemplary use of the invention's communication cables, the second communication system 66 would be a computer and the first communication system 64 a monitor associated with that computer.

In some protected uses of the the invention's communication cables (e.g., as a communication link to a laptop computer's display screen), the protective nature of the flexible tube 28 of FIG. 1 may not be required. Accordingly, other communication cable embodiments may eliminate the tube but retain the inherent safety of these cables because the optical fibers 30 are permanently fixed to the shells 22 and 24 or elements of these shells.

Although the schematic 60 of FIG. 3 illustrates a cable embodiment in which optical signals transit a cable bidirectionally, other embodiments of the invention may be structured for unilateral communication (i.e., each shell contains only lasers or only photodiodes).

It is well known that appropriate bias and modulation signals can be applied to the semiconductor lasers 32 of FIG. 3 to cause them to generate modulated optical signals in response to modulating electrical communication signals 70. The modulated optical signals then propagate along the optical fibers 30 for reception by photodiodes 34. Similarly, appropriate bias signals can be applied to the photodiodes to generate corresponding electrical communication signals 72 from mobile carriers that are generated in them in response to incident photons in the laser-generated optical signals. In addition, signals applied to these elements are typically conditioned to enhance or facilitate their functions. Accordingly, the semiconductor lasers 32 and photodiodes 34 of FIG. 3 are coupled between respective pairs of contacts 27 but that coupling may be accompanied by the insertion of signal conditioning elements such as signal amplifiers, signal attenuators and signal formatters Communication cable embodiments of the invention are electrically terminated and thus exchange electrical signals across their external interface with various communication systems. Internally, however, signals are optically coupled and the cables thus realize the advantages of optical transmission (e.g., low electromagnetic interference, long distance transmission capability, low signal distortion, light weight and electrical isolation).

Laser-generated signals are safely contained by the integral and permanent nature of the structures of these communication cable embodiments. In the context of the present invention, integral refers to an element that is formed from a single part or is made up of parts that form a whole but are structured to discourage disassembly. An integral element may, therefore, be a composite of several parts as is a permanent assembly, but in both cases, the parts:

a) are joined (e.g., with screws or rivets) so that disassembly is possible but obviously not intended and such disassembly generally requires a tool and its nature destroys the intended functions of the assembled parts, or

b) are permanently and irreversibly joined so that disassembly is destructive.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

I claim:

1. An electrically-terminated, optically-coupled communication cable, comprising:
first and second integral shells;
a flexible tube that permanently couples said first and second shells;
a plurality of optical fibers within said tube that extend into said first and second shells;
first and second arrays of electrical contacts that are respectively permanently fixed in said first and second shells to mate with external parts;
at least one laser within said first shell that is coupled between respective contacts of said first array and is arranged to radiate a light signal into a respective one of said optical fibers; and
at least one photodiode within said second shell that is coupled between respective contacts of said second array and is arranged to receive a light signal from a respective one of said optical fibers;
said cable thereby providing external electrical terminations and shielded internal optical transmission.

2. The cable of claim 1, wherein said first and second shells are plastic shells.

3. The cable of claim 1, wherein said tube is a plastic tube.

4. The cable of claim 1, wherein at least one of said electrical contacts is a pin that releasably mates with an external socket.

5. The cable of claim 1, wherein at least one of said electrical contacts is a socket that releasably mates with an external pin.

6. The cable of claim 1, wherein at least one of said electrical contacts is a solder-type contact.

7. The cable of claim 1, further including first and second housings that permanently couple said first and second arrays to said first and second shells.

8. The cable of claim 1, wherein said laser is a vertical cavity surface emitting laser (VCSEL).

9. The cable of claim 1, wherein said photodiode is a pin photodiode.

10. The cable of claim 1, further including:
at least one laser within said second shell that is coupled between respective contacts of said second array and arranged to radiate a light signal into a respective one of said optical fibers; and
at least one photodiode within said first shell that is coupled between respective contacts of said first array and arranged to receive a light signal from a respective one of said optical fibers.

11. An electrically-terminated, optically-coupled communication cable, comprising:
a first integral shell that has first and second shell ends;
a second integral shell that has third and fourth shell ends first and second arrays of electrical contacts permanently fixed in said first and fourth shell ends to mate with external parts;
a plurality of optical fibers that are permanently received through said second and third shell ends;
at least one laser within said first shell that is coupled between respective contacts of said first array and is arranged to radiate a light signal into a respective one of said optical fibers; and
at least one photodiode within said second shell that is coupled between respective contacts of said second array and is arranged to receive a light signal from a respective one of said optical fibers;
said cable thereby providing external electrical terminations and shielded internal optical transmission.

12. The cable of claim 11, further including a flexible tube that encloses said optical fibers.

13. The cable of claim 11, wherein said first and second integral shells each comprise a one-piece molded unit.

14. The cable of claim 11, further including a flexible tube that encloses said optical fibers and wherein said tube and said first and second integral shells comprise a one-piece molded plastic unit.

15. The cable of claim 11, further including a plastic tube that encloses said optical fibers and wherein said first and second integral shells are each one-piece molded plastic units and said second and third shell ends permanently receive said tube to further contain light signals from said laser.

16. The cable of claim 11, wherein at least one of said electrical contacts is a pin that releasably mates with an external socket.

17. The cable of claim 11, wherein at least one of said electrical contacts is a socket that releasably mates with an external pin.

18. The cable of claim 11, wherein at least one of said electrical contacts is a solder-type contact.

19. The cable of claim 11, further including first and second housings that permanently couple said first and second arrays to said first and second shells.

20. The cable of claim 11, wherein said laser is a vertical cavity surface emitting laser (VCSEL).

21. The cable of claim 11, wherein said photodiode is a pin photodiode.

22. The cable of claim 11, further including:
at least one laser within said second shell that is coupled between respective contacts of said second array and arranged to radiate a light signal into a respective one of said optical fibers; and
at least one photodiode within said first shell that is coupled between respective contacts of said first array and arranged to receive a light signal from a respective one of said optical fibers.

23. An electrically-terminated, optically-coupled communication cable, comprising:
an integral sheath that defines first and second shells and a flexible tube that couples said first and second shells;
first and second arrays of electrical contacts permanently fixed in said first and second shells to mate with external parts;
a plurality of optical fibers that extend through said tube and terminate within said first and second shells;
at least one laser within said first shell that is coupled between respective contacts of said first array and arranged to radiate a light signal into a respective one of said optical fibers; and
at least one photodiode within said second shell that is coupled between respective contacts of said second array and arranged to receive a light signal from a respective one of said optical fibers;
said cable thereby providing external electrical terminations and shielded internal optical transmission.

24. The cable of claim 23, wherein said integral sheath is a plastic sheath.

25. The cable of claim 23, wherein at least one of said electrical contacts is a pin that releasably mates with an external socket.

26. The cable of claim 23, wherein at least one of said electrical contacts is a socket that releasably mates with an external pin.

27. The cable of claim 23, wherein at least one of said electrical contacts is a solder-type contact.

28. The cable of claim 23, further including first and second housings that permanently couple said first and second arrays to said first and second shells.

29. The cable of claim 23, wherein said laser is a vertical cavity surface emitting laser (VCSEL).

30. The cable of claim 23, wherein said photodiode is a pin photodiode.

31. The cable of claim 23, further including:
at least one laser within said second shell that is coupled between respective pins of said second array and arranged to radiate a light signal into a respective one of said optical fibers; and
at least one photodiode within said first shell that is coupled between respective pins of said first array and arranged to receive a light signal from a respective one of said optical fibers.
